(19) United States
(12) Patent Application Publication
(10) Pub. No.: US 2025/0142593 A1
(43) Pub. Date: May 1, 2025

(54) METHODS AND APPARATUS FOR SIDELINK COMMUNICATIONS IN MODE-1

(71) Applicant: MediaTek Singapore Pte. Ltd., Singapore (SG)

(72) Inventors: Junqiang CHENG, Beijing (CN); Tao CHEN, Beijing (CN)

(21) Appl. No.: 18/836,958

(22) PCT Filed: Apr. 4, 2023
(86) PCT No.: PCT/CN2023/086105

§ 371 Date: Aug. 8, 2024

(30) Foreign Application Priority Data
Apr. 6, 2022 (WO) PCT/CN2022/085306

(51) Int. Cl. H04W 72/25; H04L 5/00; H04W 72/0446

(52) U.S. Cl. CPC H04W 72/25; H04L 5/0055; H04W 72/0446

(57) ABSTRACT

Apparatus and methods are provided for mode-1 sidelink communication on unlicensed frequency bands. In one novel aspect, the UE receives SL grant from the gNB/network apparatus, obtains channel access information and performs a channel access procedure for a scheduled SL resource based on the channel access information before the SL transceiving. In one embodiment, the channel access information is based on one or more elements including an HARQ ACK/NACK status from the Uu link, an ACK/NACK status from the SL link, and network loading status. In one embodiment, the gNB/network apparatus determines/derives channel access information based on the channel access related information from UE. In one embodiment, the channel access information is determined based on the CAPC. In one embodiment, the SL resource scheduling is a DG or CG mode. In one embodiment, the one or more scheduled resources are overbooked.

### CROSS REFERENCE TO RELATED APPLICATIONS

This application claims priority from International Application No. PCT/CN2022/085306, titled “Methods for SL-U communications in Mode 1” with an international filing date of Apr. 6, 2022. The disclosure of the foregoing documents is incorporated herein by reference.

### TECHNICAL FIELD

The disclosed embodiments relate generally to wireless communication, and, more particularly, to mode-1 sidelink communication on unlicensed frequency bands.

### BACKGROUND

Sidelink (SL) communication was introduced to enable direct transmission between two user equipments (UEs), which is also known as the device-to-device (D2D) communications. With the development of 3GPP normative works, the scenarios of sidelink are extended to UE-to-network relay, public safety, vehicle-to-everything (V2X) communications and so on. The critical role of sidelink in long term evolution (LTE) and the new radio (NR) has made it an inevitable remedy to support diverse use cases of future wireless communications.

To meet the increased demands of wireless data traffic, using unlicensed frequency bands has drawn a lot of attention in the wireless industry to improve the capacity of future wireless communication systems. The utilization of unlicensed spectrum for sidelink (SL-U) communications is regarded as the most promising direction for further development of sidelink communication. However, some radio access technologies (RATs), such as NR-U communications, Wi-Fi, etc., have already operated on the unlicensed frequency bands. One of the most critical issues of allowing sidelink communications to operate on the unlicensed frequency bands is to ensure the fair and harmonious coexistence with other RATs.

For SL-U design, one of the most significate issues is the fair and harmonious coexistence with other radio access technologies (RATs) that operated on the same unlicensed spectrum, such as Wi-Fi and NR-U. To design a SL-U coexistence scheme, the channel access/listen-before-talk (LBT) mechanism should be the regulation requirements. Besides, the SL resource allocation schemes, such as Mode-1 and/or Mode-2 resource allocation scheme, should be respected to inherit the SL and/or SL-enhancement features. A better design of channel access scheme for SL-U has the potential to improve the channel access probability and reduce the latency for the SL-U UEs. These issues will be detailed in the rest of this disclosure.

Improvements and enhancements are required for sidelink resource allocation in mode-1 on unlicensed frequency bands to ensure harmonious coexistence with other RATs.

### SUMMARY

Apparatus and methods are provided for mode-1 sidelink communication on unlicensed frequency bands. In one novel aspect, the UE sends channel access related/updated information and scheduling request to gNB, receives SL grant from the gNB for an SL transceiving on an unlicensed frequency band, obtains channel access information (CAI) for the allocated SL resources and performs a channel access procedure for the allocated SL resource based on the channel access information before the SL transceiving, reports channel access result to gNB, transmit packet(s) in the following COT if the allocated resource is judged as idle, shares the remaining resource(s) within the COT to other UEs based on COT sharing principle. In one embodiment, the channel access related information (CARI) includes one or more elements including a contention window (CW) range, a CW value, a random back-off counter, a listen-before-talk (LBT) type for the channel access procedure, an LBT result, a gap margin, and a maximum channel occupancy time (COT). In one embodiment, the channel access information is updated based on one or more elements including an HARQ ACK/NACK status from the Uu link, an ACK/NACK status from the SL link, and network loading status. In one embodiment, the UE sends the channel access related information to the gNB and a scheduling request. In one embodiment, the channel access related information includes the channel access information determined by the UE. In another embodiment, only channel access related information, such as the traffic type, quality of service (QoS), 5G QoS identifier (5QI), PC5 QoS identifier (PQI), channel access priority class (CAPC) are included. The gNB/network apparatus determines/derives channel access information based on the channel access related information from UE. In one embodiment, the channel access information is determined based on the CAPC. In one embodiment, the SL resource scheduling is a dynamic grant (DG). The DG mode SL grant is sent to the UE using a DCI and/or MAC control element (CE). In another embodiment, the SL resource scheduling is a configured grant (CG). The CG mode SL grant is sent to the UE using radio resource control (RRC) or MAC CE. In yet another embodiment, the channel access information is updated for one or more latter allocated resources in the SL grant based on one or more factors comprising a HARQ feedback for an earliest successful COT, a distance Tw from an end of the reference duration corresponding to the earliest SL channel occupancy after the last update of contention window size of a CAPC value. In one embodiment, the one or more scheduled resources are overbooked. In another embodiment, the Uu link between the UE and the gNB is on a licensed frequency band.

In one novel aspect, the gNB/network apparatus receives a scheduling request and channel access related information from a UE at t0 for an SL transceiving on an unlicensed frequency band between the UE and one or more other UEs. The gNB allocates one or more SL resources starting from time t3 based on the scheduling request and channel access related information, wherein a gap between t3 and t0 is determined at least for channel access procedure and transmits a SL grant for the SL transceiving on the unlicensed frequency band. In one embodiment, the gap between t0 and t3 is based on Uu link signaling receiving time, message parsing and preparation time, channel access duration, gap margin, and resource occupancy status. In one embodiment, wherein the SL grant in DCI is simultaneously sent to one or more

UEs. In another embodiment, the channel access information is updated based on feedback information from the UE.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a schematic system diagram illustrating an exemplary wireless network for sidelink data communication on unlicensed frequency bands with other coexistence RATs in accordance with embodiments of the current invention.

FIG. 2 illustrates an exemplary diagram for the sidelink resource allocation in mode-1 on the unlicensed frequency bands in accordance with embodiments of the current invention.

FIG. 3 illustrates exemplary diagrams for overbooking SL resources and performing different types of LBT for channel access in accordance with embodiments of the current invention.

FIG. 4 illustrates exemplary diagrams for channel access information and SL resource allocation in accordance with embodiments of the current invention.

FIG. 5 illustrates exemplary diagrams for overbooking SL resources on unlicensed frequency bands in accordance with embodiments of the current invention.

FIG. 6 illustrates exemplary diagrams for channel access information settings and updates in accordance with embodiments of the current invention.

FIG. 7 illustrates an exemplary flow chart of UE for the SL resource allocation for mode-1 on unlicensed frequency bands in accordance with embodiments of the current invention.

FIG. 8 illustrates an exemplary flow chart of network apparatus for the SL resource allocation for mode-1 on unlicensed frequency bands in accordance with embodiments of the current invention.

### DETAILED DESCRIPTION

Reference will now be made in detail to some embodiments of the invention, examples of which are illustrated in the accompanying drawings.

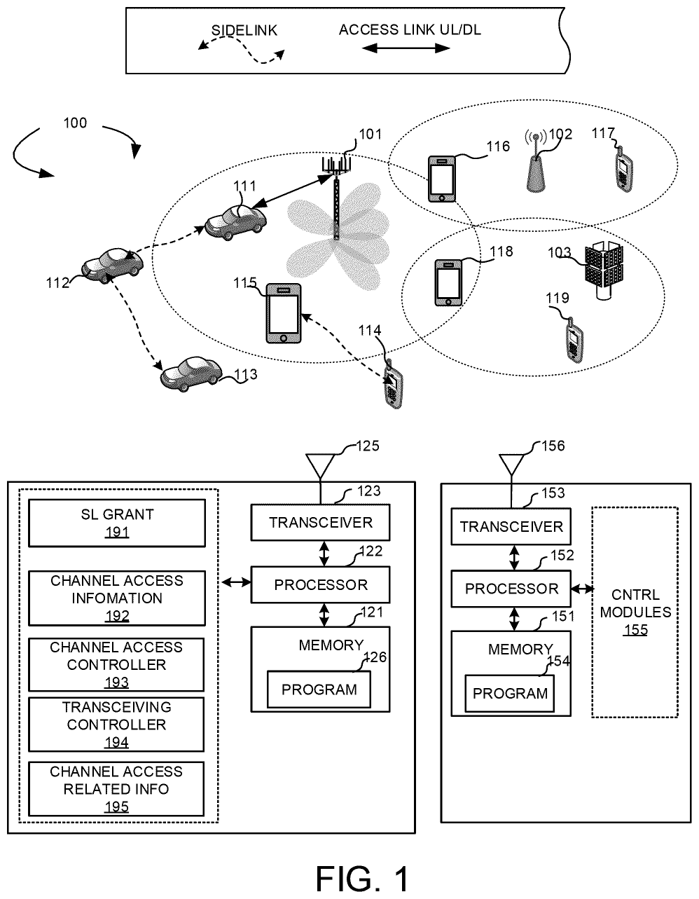

FIG. 1 is a schematic system diagram illustrating an exemplary wireless network for sidelink data communication on unlicensed frequency bands with other coexistence RATs in accordance with embodiments of the current invention. Wireless network 100 includes multiple communication devices or mobile stations, such as user equipments (UEs) 111, 112, 113, 114, and 115, which are configured with sidelink resources on unlicensed frequency bands. The exemplary mobile devices in wireless network 100 have sidelink capabilities. Sidelink communications refer to the direct communications between terminal nodes or UEs without the data going through the network. For example, UE 114 communicates with UE 115 directly without going through links with the network units. The scope of sidelink transmission also supports UE-to-network relay to extend the service range of an a network, where the inter-coverage UE acts as the relay node between network apparatus (for example, gNB, or eNB) and an out-of-coverage UE. For example, UE 112 is connected with base station 101 through an access link. UE 111 provides network access for out-of-coverage UE 112 through sidelink relay. The base station, such as base station 101, may also be referred to as an access point, an access terminal, a base station, a Node-B, an eNode-B (eNB), a gNB, or by other terminology used in the art. The network can be a homogeneous network or heterogeneous network, which can be deployed with the same frequency or different frequencies. Base station 101 is an exemplary base station. With the demands for more capacity and the development of sidelink communication, it is important for the sidelink devices to use the unlicensed frequency bands and be harmoniously coexistence with devices with other RATs operating on the same unlicensed frequency bands. For example, neighboring UEs 116 and 117 communicate with base station 102 through other RATs, such as Wi-Fi, sharing the same unlicensed frequency band. Neighboring UEs 118 and 119 communicate with base station 103 through other RATs, such as NR, sharing the same unlicensed frequency band.

For sidelink transmissions on the unlicensed spectrum (SL-U), efficient resource allocation is one of the most critical issues to ensure the fair coexistence with other RATs operated in the unlicensed spectrum, such as NR-U and Wi-Fi, etc. For Mode-1, the resource allocation is scheduled by the gNB using the Uu interface. In order to guarantee fair coexistence with other RATs operated on the unlicensed spectrum, the LBT/channel access procedures can be configured for the SL-U UE to perform before it can access the unlicensed spectrum. Besides, the Mode-1 scheme is a gNB controlled resource allocation scheme for sidelink. The combination design of LBT and Mode-1 can be a promising solution to achieve a harmonious-coexistence and high-efficiency SL-U technology. As an illustrated example, UE 111 is connected with gNB 101 through Uu link. In one embodiment, the connection in the Uu link is on the licensed bands. For mode-1, the UE 111 receives SL grant for a SL communication with UE 112. In one embodiment, UE 112 is an out-of-network UE. In another embodiment, UE 111 can also share the SL resources received in the SL grant with UE 112 for SL transceiving between UE 112 and UE 113.

FIG. 1 further illustrates simplified block diagrams of a mobile device/UE for operating on the unlicensed frequency band. UE 111 has an antenna 125, which transmits and receives radio signals. An RF transceiver circuit 123, coupled with the antenna, receives RF signals from antenna 125, converts them to baseband signals, and sends them to processor 122. In one embodiment, the RF transceiver may comprise two RF modules (not shown). RF transceiver 123 also converts received baseband signals from processor 122, converts them to RF signals, and sends out to antenna 125. Processor 122 processes the received baseband signals and invokes different functional modules to perform features in the UE 111. Memory (or computer-readable medium, or storage medium) 121 stores program instructions and data 126 to control the operations of the UE 111. Antenna 125 sends uplink transmission and receives downlink transmissions to/from base stations.

UE 111 also includes a set of control modules that carry out functional tasks. These control modules can be implemented by circuits, software, firmware, or a combination of them. A SL grant module 191 receives an SL grant from a gNB for an SL transceiving on an unlicensed frequency band between the UE and one or more other UEs in a wireless network, wherein the SL grant includes one or more allocated SL resources on the unlicensed frequency band for the SL transceiving. A channel access information module 192 obtains channel access information for the one or more allocated SL resources in the unlicensed frequency band. A channel access 10 controller 193 performs a channel access procedure for a allocated SL resource based on the channel access information before the SL transceiving, wherein the channel access procedure determines whether the allocated resource is idle. A transceiving controller 194 transmits and receives SL packets on the allocated SL resource when the channel access procedure is successful. A channel access related information module 195 sends a scheduling request and 15 channel access related information to the gNB, and wherein the SL grant is triggered by the scheduling request.

FIG. 1 further illustrates simplified block diagrams of a network entity (or network apparatus), such as a gNB 101. gNB 101 has antenna 156, which transmits and receives radio signals. An RF transceiver circuit 153, coupled with the antenna, receives RF signals from 20 antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 101. Memory (or computer-readable medium, or storage medium) 151 stores program instructions and data 154 to control the operations of gNB 101. gNB 101 also includes a set of control modules 155 that carry out functional tasks to communicate with mobile devices, such as UE 111. Control modules 155 are configured to receive a scheduling request and channel access information from a user equipment (UE) at time to in a wireless network, wherein the scheduling request is for a sidelink (SL) transceiving on an unlicensed frequency band between the UE and one or more other UEs, allocate one or more SL resources starting from time t3 based on the scheduling request and channel access information, wherein a gap between t3 and t0 is determined at least for channel access procedure, and transmit a sidelink (SL) grant for an SL transceiving on an unlicensed frequency band between the UE and one or more other UEs in a wireless network, wherein the SL grant includes one or more allocated SL resources on the unlicensed frequency band for the SL transceiving.

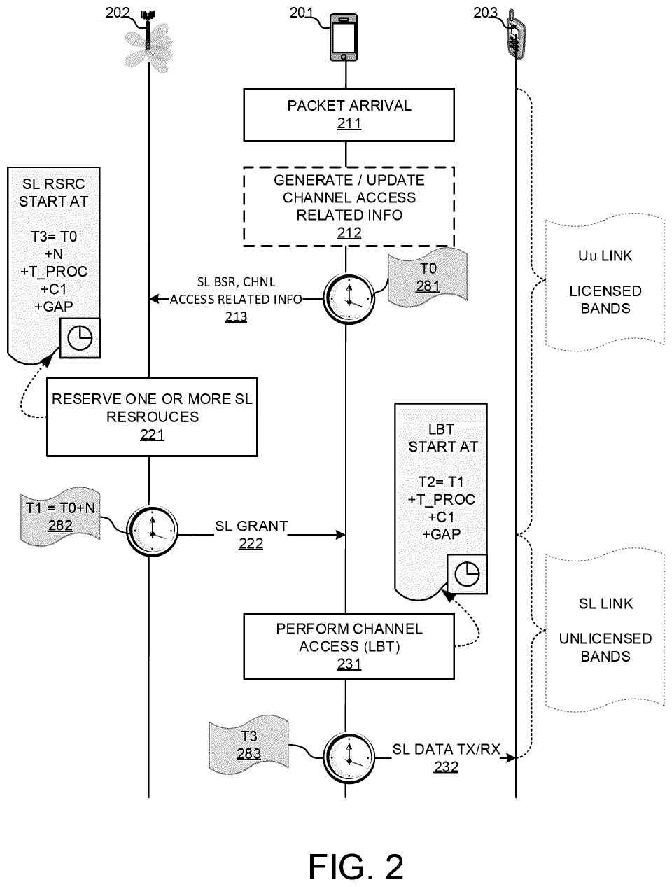

FIG. 2 illustrates an exemplary diagram for the sidelink resource allocation in mode-1 on the unlicensed frequency bands in accordance with embodiments of the current invention. UE 201 is connected with gNB 202 through a Uu link. In one embodiment, the Uu link is on the licensed bands. UE 201 communicates with UE 203 through sidelink on unlicensed frequency bands. At step 211, packets for transceiving on the SL arrive at UE 201, for example, UE 201 wants to transmit packets to UE 203. In one embodiment, at step 212, UE 201 generates and/or updates channel access related information. At step 213, at time t0 281, UE 201 sends scheduling request to gNB 202 for resource allocation with channel access related information. The scheduling request can be (pre-)configured to include buffer status report (BSR) and/or channel access/LBT information. Particularly, the LBT information can be configured to include one or more channel access information elements including the channel access priority class (CAPC), the contention window range [CW_{min,p}, CW_{max,p}], contention window value CWₚ (CW_{min,p}≤CWₚ≤CW_{max,p}), random back-off counter c1 (uniformly generated/drawn from [0, CWₚ]), the maximum channel occupancy time (COT) T_{mcot,p}. If the LBT information is included in the scheduling request, it can be (pre-)generated before T0 281 according to the packet information. For example, channel access related information elements the CAPC, 5G QoS identifier (5QI), PC5 QoS (PQI) are generated before T0 281. The scheduling request can be configured on the uplink control information (UCI).

After receiving the scheduling request, at step 221, gNB 202 reserves one or more SL resources in the future time considering the information received from UE 201. In one embodiment, the SL resources are consecutive. In one embodiment, the future time for the SL resources can be configured as t3=t0+n+T_proc+c1′+gap, where n is the duration of DCI receiving. T_proc is the processing time for DCI parsing and preparation. c1′ is the minimum LBT sensing time at UE 201 based on the counter c1 if it is reported from UE 201 (c1′≥c1). In this disclosure, the value of random back-off counter c1 can be generated by UE 201 then carried on the scheduling request to gNB 202. Alternatively, c1 can also be generated by the gNB 202 according to CAPC. In this case, the CAPC of the packet should be carried on the scheduling request from UE 201, and the value of c1 generated by gNB should be indicated in the following downlink control information (DCI) to UE 201 together with the resource assignment/scheduling/configuration. Besides, the gap in the formula is the protection margin to combat the potential LBT sensing failure. In one embodiment, the value of gap can be configured according to the LBT failure probability, and/or the ACK/NACK feedback(s) status, and/or the channel congestion control information. At step 222, gNB 202 sends SL grant to UE 201. The SL grant is sent at time t1 282, where t1=0+n. The SL grant can be configured to carry the resource information and/or LBT configuration (e.g., CW or counter c1), when it is not generated by the UE side, in a DCI way or RRC way. Particularly, a time resource indication value (TRIV) and/or a resource reservation interval (RRI), and/or a resource indication can be used to indicate one or multiple candidate consecutive/non-consecutive resource(s). Alternatively, the candidate resources can be used for initial transmission and/or re-transmission and/or repetition and/or ACK/NACK feedback and/or overbooking. If the repetition is allowed, the repetition number can be indicated via DCI or (pre-)configured. In another embodiment, the channel access/LBT information is configured to include one or more channel access information elements including channel access/LBT type, the contention window size, random back-off counter c1, the gap margin, the maximum channel occupancy time T_{mcot,p}, etc. In this disclosure, c1+gap can be merged as one parameter alternatively by considering the gap margin and c1 together. If the resource is assigned/scheduled in RRC way, the inter-arrival time/duration of two consecutive packets is configured to be larger than the (max) contention window.

After receiving the SL grant from the gNB 202, at step 231, UE 201 performs channel access/LBT based the indication in the SL grant at time t2, where t2=t1+T_proc. The random back-off counter c1 carried on the SL grant or generated by UE 201 will be used in the random back-off stage of the LBT. The gap margin indicated in the SL grant can grant more flexible time to try LBT in case of LBT sensing failure during the initial LBT procedures.

In another embodiment, every SL-U UE at least the UEs in Mode-1 reports the channel access/LBT procedure status and/or the LBT results and/or the COT initialization information to gNB 202. This information can be used to assist the gNB to conduct the resource scheduling. For example, gNB 202 will first exclude the resources have been occupied by a successful LBT at least in the corresponding COT duration. Next, based on the max contention window length, and/or the random back-off counter c1 carried in the UCI or generated by the gNB itself, the potential LBT length can be predicted, which can be further used to determine the candidate resource position for UE 201 in the remaining available resource set after the first step. Alternatively, the priority of packets for UE 201 can be used to assist gNB achieve a priority enabled resource assignment/scheduling. If the LBT is successful, at step 232, UE 201 will transmit packet to UE 203 at time t3 during the following COT, where t3≥t2+c1+gap. The specific position of t3 283 is determined by the actual LBT status. If LBT fails, UE 201 will continue to try LBT for the overbooking resources before the packet delay budget. UE 201 will transmit packet when at least one LBT is successful before the assigned overbooking resources. The resources in the COT can be configured to transmit the SL ACK/NACK. With the SL ACK/NACK feedback(s), the UE 201 can update Type 1 channel access (LBT) information, such as the contention window. Alternatively, UE 201 sends feedback through Uu ACK/NACK to gNB 202. gNB 202 updates the Type-1 channel access (LBT) information with the Uu ACK/NACK feedback(s). In one embodiment, the channel access/LBT information is updated by UE 201, the updated channel access information is sent to the gNB 202 for the resource scheduling/assignment. In another embodiment, the channel access/LBT information is updated by gNB 202. The updated channel access information is sent to UE 201 for the subsequent channel access/LBT configuration. In one embodiment, the Uu link between UE 201 and gNB 202 are on the licensed frequency bands. The SL between UE 201 and UE 203 are on the unlicensed frequency bands.

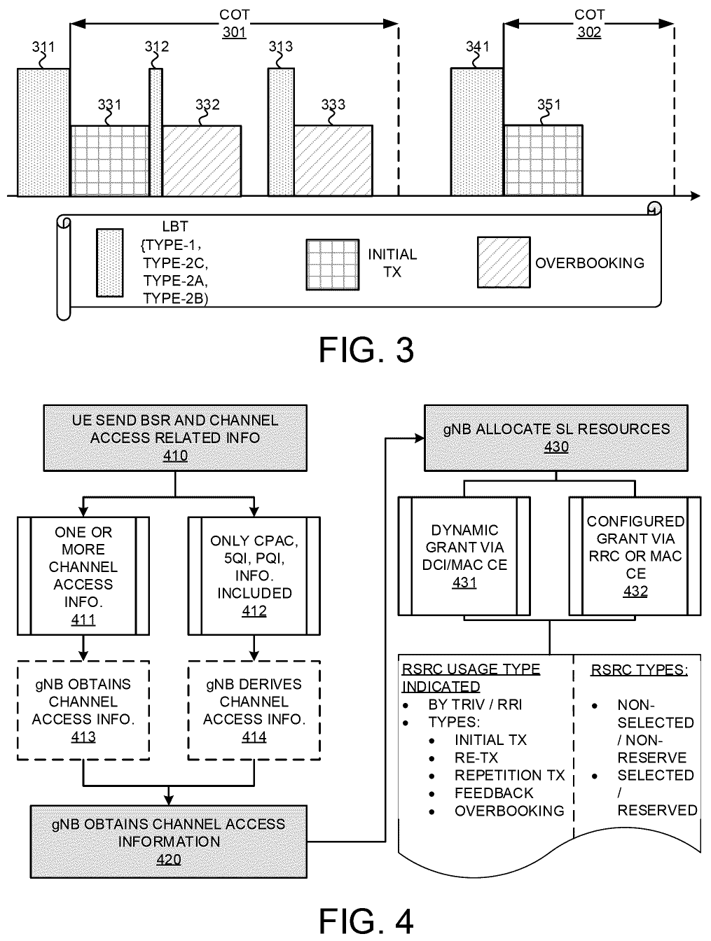

FIG. 3 illustrates exemplary diagrams for overbooking SL resources and performing different types of LBT for channel access in accordance with embodiments of the current invention. In one embodiment, the configured/scheduled/assigned resources for a SL-U UE are continuous. For example, resources 331, 332, 333, and 351 are configured for SL-U. Resource 331 is for the initial TB transmission and resources 332, 333, 351 are overbooking resources. In one embodiment, resources 331, 332, 333, and 351 are multiple continuous slots. In another embodiment, the resources are non-continuous. Before the first resource 331, at step 311, the SL-U UE executes Type-1 channel access (CAT-4 LBT) as configured/indicated in the SL grant to initiate the COT 301. Overbooking resources 332 and 333 are within the initiated COT 301. In one embodiment, Type-2 channel access is configured in the DCI or RRC for the UE to perform before the corresponding resource. For example, LBT 312 is a Type-2A channel access (CAT-2 LBT with 25 us sensing) or Type-2B channel access (CAT 2 LBT with 16 us sensing). LBT 313 is performed before resource 333 and is a Type-2C channel access (CAT 1 LBT). In another embodiment, if the LBT type (channel access type) is not indicated in the DCI or RRC, the UE can determine the LBT type according to the gap duration between two consecutive resources. For example, the UE determines to perform Type-2C LBT before accessing resource 332 based the gap between resource 331 and 332. The UE determines to perform Type-2A or Type-2B LBT before resource 333 based on the gap between resources 332 and 333. Alternatively, if the latter resources, such as resource 351, are out of the initiated COT 301, the UE performs Type-1 channel access (CAT 4 LBT), LBT 341, as configured/indicated in the DCI. In one embodiment, the contention window value CWₚ is updated for LBT 341, according to the ACK/NACK feedback(s) if the HARQ mechanism is configured. COT 302 is initiated. In another embodiment, the contention window value CWₚ is updated according to the duration Tw from the end of the reference duration corresponding to the earliest COT after the last update of CWₚ. For both cases, the random back-off counter should be generated according to the updated contention window size. Alternatively, if the second LBT is performed at least a preconfigured number of sensing slots away from the end of the previous COT, the random back-off counter of the previous LBT can be re-used. In one embodiment, the preconfigured number of sensing slots is four. In some embodiments, the reference duration is defined as a duration starting from the beginning of the channel occupancy until the end of a first slot where at least one unicast and/or multicast PSSCH with HARQ ACK/NACK enabled is transmitted over all the resources allocated for the PSSCH, or until the end of the first transmission burst by the UE that contains unicast PSSCH(s) transmitted over all the resources allocated for the PSSCH, whichever occurs earlier.

FIG. 4 illustrates exemplary diagrams for channel access information and SL resource allocation in accordance with embodiments of the current invention. In one embodiment, at step 410, the UE sends BSR and channel access related information to the gNB for SL grant on unlicensed frequency bands. In one embodiment 411, the channel access related information from the UE includes one or more channel access information elements, such as a contention window (CW) range, a CW value, a random back-off counter, a LBT type for the channel access procedure, a gap margin, and a maximum COT period. In this embodiment, at step 413, gNB obtains the channel access information from the UE. In one embodiment, the information is sent through PUCCH and/or physical uplink shared channel (PUSCH). In another embodiment 412, the UE sends one or more channel access information elements including a traffic type, quality of service (QoS), 5QI, PQI, and CAPC. In this embodiment, at step 414, the gNB derives channel access information based on the UE information. In one embodiment, the channel access information is determined by the gNB based on CAPC. At step 420, gNB obtains channel access information based on the channel access related information received from the UE. At step 430, the gNB allocates/reserves one or more SL resources in the future time based on the channel access related information received from the UE (or the obtained channel access information). In one embodiment, the gNB allocates overbooking resources for the SL grant. The SL resource scheduling can be configured with dynamic grant (DG) mode 431 or configured grant (CG) mode 432. The resources reserved can be selected/reserved resources or non-selected/non-reserved resources for both the DG and CG mode.

For resource scheduling DG mode 431, for the initial transmission of any transport block (TB) in DG mode, the resources can be non-selected/non-reserved via DCI and/or MAC-CE configuration including resources considering updated channel access/LBT information (e.g., contention window). In one embodiment, the resources include one or more resources for the initial transmission with overbooking. In another embodiment, the updated channel access information includes one or more ACK/NACK feedbacks. In one embodiment, for another initial transmission of the next/following TBs, if the one or more allocated resources for the first TB, such as the overbooking resource, are still available after the arrival of the next/following TBs, these resources are used for the initial transmission for the next/following TBs as (pre-)configured. In this case, the UE sends ACK feedback in Uu to the gNB only when the transmission on the last assigned/scheduled resource is successful. Otherwise, the UE will always send NACK feedback in Uu. On the gNB side, the gNB will schedule any new resources for the UE only when the gNB receives the NACK of the last assigned/scheduled (overbooking) resource. Otherwise, the gNB will not schedule new resource for UE. For the re-transmission in DG mode, the resources can be (pre-)selected/reserved by the same DCI and/or MAC-CE for the initial transmission including (overbooking) re-transmission resources with or without ACK/NACK feedback(s). Alternatively, the resource can be non-selected/non-reserved and/or dynamic grant by a new DCI and/or MAC-CE for (overbooking) re-transmission resources with or without ACK/NACK feedback(s). The ACK/NACK feedback(s) can be configured as Uu ACK/NACK and/or SL ACK/NACK on licensed and/or unlicensed bands, which can be used to indicate the update of LBT information.

For resource scheduling CG mode 432, for the initial transmission of the first TB in CG mode, the one or more SL resources can be non-selected/non-reserved via RRC configuration. In one embodiment, the one or more SL resources include overbooking resources. In one embodiment, the SL grant in the CG is sent to the UE via RRC configuration with DCI and/or MAC CE. In another embodiment, the updated channel access related information includes one or more ACK/NACK feedbacks. In another embodiment, for another initial transmission for the next and/or following TBs, the resources can be selected/reserved via the same RRC for the initial transmission. The resources used for another initial transmission includes overbooking resources. The one or more resources is used for another initial transmission when another initial transmission is configured with the max contention window smaller than inter-arrival time, such that the channel access/LBT is performed before the allocated resource. For the re-transmission in CG mode, the resources, including the overbooking resources, can be selected/reserved by the same RRC for initial transmission as re-transmission resources with or without ACK/NACK feedback(s). Alternatively, the resources can be non-selected/non-reserved and/or dynamic grant by a new DCI and/or MAC-CE as re-transmission resources with or without ACK/NACK feedback(s).

The resources, including the overbooking resources, allocated in both DG mode 431 and CG mode 432, can be used for different types of transmission, including the initial transmission, the retransmission, the repetition transmission, feedback, and overbooking resources considering the potential channel access failures. In one embodiment, the type of resources can be included in the SL grant as a TRIV.

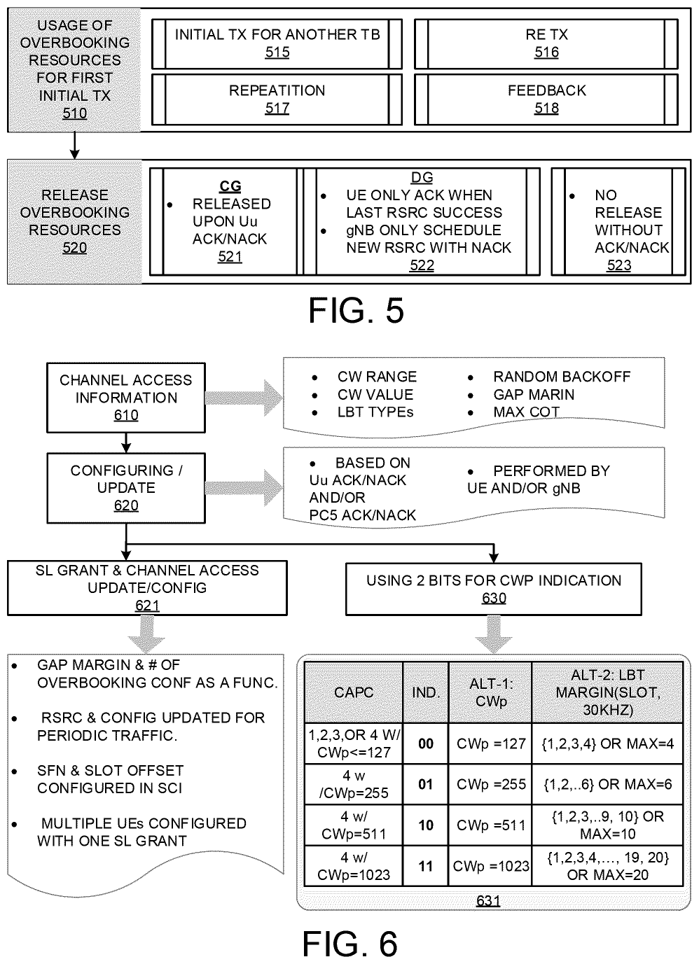

FIG. 5 illustrates exemplary diagrams for overbooking SL resources on unlicensed frequency bands in accordance with embodiments of the current invention. In one embodiment, the SL grant includes overbooking resources for the SL transceiving on unlicensed frequency bands. In one embodiment 510, the overbooking resources are used in different ways. The overbooking resources can be used for another initial transmission (515), used for retransmission (516), for repetition transmission (517), or for feedbacks (518). In one embodiment 520, the overbooking resources are released based on different configurations. In a CG mode (521), if the ACK/NACK feedback(s) is enabled, the overbooking resources can be released by the gNB according to the Uu ACK/NACK feedback(s), and the LBT information before the next resource can be updated according to the SL ACK/NACK feedback(s) and/or Uu ACK/NACK feedback(s) by UE and/or gNB. In a DG mode (522), the UE only sends ACK to the gNB when the last resource in the SL grant is successful. Accordingly, the gNB only schedule new resources through DCI and/or MAC CE when a NACK is received from the UE. In the CG mode when no ACK/NACK is configured (523), no overbooking resources can be released in Uu, and the LBT information before the next resource can be updated by gNB or UE according to the distance Tw from the end of the reference duration corresponding to the earliest successful initiated COT.

FIG. 6 illustrates exemplary diagrams for channel access information settings and updates in accordance with embodiments of the current invention. In one embodiment 610, the channel access information is configured for the channel access procedure. The channel access information includes a contention window (CW) range, a CW value, a random back-off counter, a listen-before-talk (LBT) type for the channel access procedure, a gap margin, and a maximum channel occupancy time (COT). The elements of channel access information are either determined by the UE or by the gNB based on channel access related information from the UE. In one embodiment 620, the channel access information is configured and updated dynamically, based on Uu ACK/NACK and/or SL ACK/NACK information. The channel access information can be configured and updated by the UE or by the gNB or in combination.

In one embodiment 621, one or more parameters/elements are configured and updated. In one embodiment, the gap margin and the resource overbooking number can be (pre-)configured as a function. In one embodiment, the gap margin is configured based on one or more factors including the HARQ-ACK/NACK feedback(s) status, LBT failure probability, the channel loading status information, the channel congestion control information, the layer1 priority, and other factors. In another embodiment, the function between gap margin and overbooking resource number can be modeled as Gap+M=K in slot, where Gap is the configured gap margin, M is the number of overbooked resources as configured/indicated in the DCI, and K can be up to (pre-)configuration.

In another embodiment, in CG mode, the gNB can schedule a set of resources to UE for the transmission of several periodic packets in the RRC. For the initial transmission of the first packet, the UE requests resource scheduling and performs the configured channel access/LBT before the first scheduled resource Rₓ. If the following scheduled resource Rₓ₊₁ is out of the previous initiated COT, the LBT information before Rₓ₊₁ can be updated by gNB or UE according to the ACK/NACK feedback(s) in Uu or SL (if it is available) in the previous successful initiated COT, and/or the distance Tw from the end of the earliest successful initiated COT. In yet another embodiment, the UE updates the channel access/LBT information, such as the contention window value CWₚ according to the ACK/NACK feedback(s) if it is available, and/or Tw as mentioned above. Subsequently, the UE updates the random back-off counter c1 from [0, CW_{p,new}]. With the updated LBT information, the UE can determine the LBT trigger time before the latter resource Rₓ₊₁ with a (new) gap margin. The (new) gap margin can be (pre-)configured, and/or updated by the UE. Alternatively, if ACK/NACK feedback(s) is(are) available, the UE reports this information to gNB after receiving it. The gNB will update LBT information, such as the contention window value CWₚ, the random back-off counter c1 based on the reported ACK/NACK feedback(s) from UE, and then transmit the updated LBT information to UE. Alternatively, if the ACK/NACK feedback is not available, the gNB can update the LBT information based on the distance Tw between two consecutive allocated resources, then transmit this information to the UE. After receiving the DCI with updated LBT information, the UE can trigger LBT at configured slot with a (new) gap margin before the latter resource Rₓ₊₁. The (new) gap margin can be (pre-)configured, and/or updated by the gNB, and/or updated by the UE.

In one embodiment for the periodic traffic, the system frame number (SFN) together with slot offset can be configured in the SCI to determine the resource position for periodic packet. Additionally, the sub-channel size can be set as 20 MHz to be aligned with the resource set of the other RATs (like WIFI) for co-existence. The sub-channel can be comprised of interlaced RBs or interlaced RB sets. In case the sub-channel size is smaller than 20 MHz (i.e., one resource set is comprising of multiple sub-channels), the 1st SCI transmission can be fixed or configured in the one sub-channel (e.g., the first sub-channel) within 20 MHz resource set. It can avoid blind detection at SL-U UE supposing the UE will typically occupy one resource set in the unlicensed spectrum with LBT bandwidth of 20 MHz.

In one embodiment, the SL grant in DCI is simultaneously sent to one or more UEs. Within a COT, multiple UEs can be scheduled simultaneously by the gNB. In this case, the DCI may not need to be transmitted for the scheduled UE when transmitting the data at the scheduled resource (or preferred resources) indicated by the gNB. Whether the DCI should be transmitted associated with the data by the gNB or not can be up to (pre-)configuration. For the scheduling UE, the scheduling grant to schedule multiple UEs (or signaling to indicate the preferred resources to multiple UEs for transmission) can be sent via single DCI and/or MAC-CE to include multiple scheduling information (or preferred resource information) corresponding to the multiple UEs. In this case, a bit map can be used to indicate which UE is scheduled and the corresponding field in DCI and/or MAC-CE will be used to further indicate the scheduling information (or preferred resource information) of each scheduled UE. To differentiate with the existing DCI format, the new DCI format and/or DCI format indicator can be introduced. Whether such new format is supported within a COT for scheduling a group of UEs can be up to (pre-)configuration or an indicator in the COT information.

In another embodiment, within a COT, the gNB can send multiple DCIs on the different sub-channels to the multiple UEs, in this case, the (potential) scheduled UEs or the UEs sharing the same COT should monitor DCIs in the multiple sub-channels in addition to the first sub-channel. Whether the UEs sharing the COT or the (potential) scheduled UEs should monitor the multiple sub-channels or only the first sub-channel can be up to (pre-)configuration or an indicator in the COT information.

In one embodiment 630, a 2-bit indication for CWp and margin gap update is used for the channel access information update. If the channel access/LBT information is generated and updated by gNB, the UE should send the packet CAPC to the gNB. Alternatively, the UE can be (pre-)configured to send the CAPC only for the LBT information initial generation. After that, the UE updates the changed CAPC to gNB only when the CAPC is changed. Otherwise, the UE does not send CAPC to gNB for every packet to save signaling consumption. The gNB will use the latest updated CAPC to generate or update channel access/LBT information.

In one embodiment, a mapping relation between the contention window size or LBT duration margin and a new indication factor can be (pre-)configured for the gNB and UE. As shown in table 631, two new bits (IND.) can be added in the PUCCH and/or MAC-CE to indicate the contention window size. Specifically,
if the CAPC is(are) ‘1’, ‘2’, ‘3’, or ‘4’, with the contention window size smaller than ‘255’, the two new bits in PUCCH and/or MAC-CE can be configured as “00”.
If the CAPC is ‘4’ and the contention window size is ‘255’, the two new bits in PUCCH and/or MAC-CE can be configured as “01”.
If the CAPC is ‘4’ and the contention window size is ‘511’, the two new bits in PUCCH and/or MAC-CE can be configured as “10”.
If the CAPC is ‘4’ and the contention window size is ‘1023’, the two new bits in PUCCH and/or MAC-CE can be configured as “11”.

Under this configuration, after the gNB receives the new indication factor in the PUCCH and/or MAC-CE,
if it is “00”, the gNB can configure the contention window size is 127.
If it is “01”, the gNB can configure the contention window size is 255.
If it is “10”, the gNB can configure the contention window size is 511.
If it is “11”, the gNB can configure the contention window size is 1023.

With the contention window size, the gNB can estimate the LBT duration margin and then schedule the resources for UE. Alternatively, another example, the gNB can directly configure the LBT duration margin as n slot(s) according to the new indication factor in the PUCCH and/or MAC-CE. For example,
if the new indication factor is “00”, n can be configured as n ∈ {1,2,3,4}.
If the new indication factor is “01”, n can be configured as n ∈ {1,2,3,4, 5,6}.
If the new indication factor is “10”, n ∈ {1,2,3,4, 5,6,7,8,9,10}.
If the new indication factor is “11”, n ∈ {1,2,3,4, 5,6,7,8,9,10,11,12,13,14,15,16,17,18,19,20}.

It should be noted that the relation between the new indication factor in the PUCCH and/or MAC-CE and the CAPC/contention size, or the LBT duration margin n described previously is just an example for reference, and the other relations and values can also be configured under this principles/rules according to the specific LBT and resource configuration.

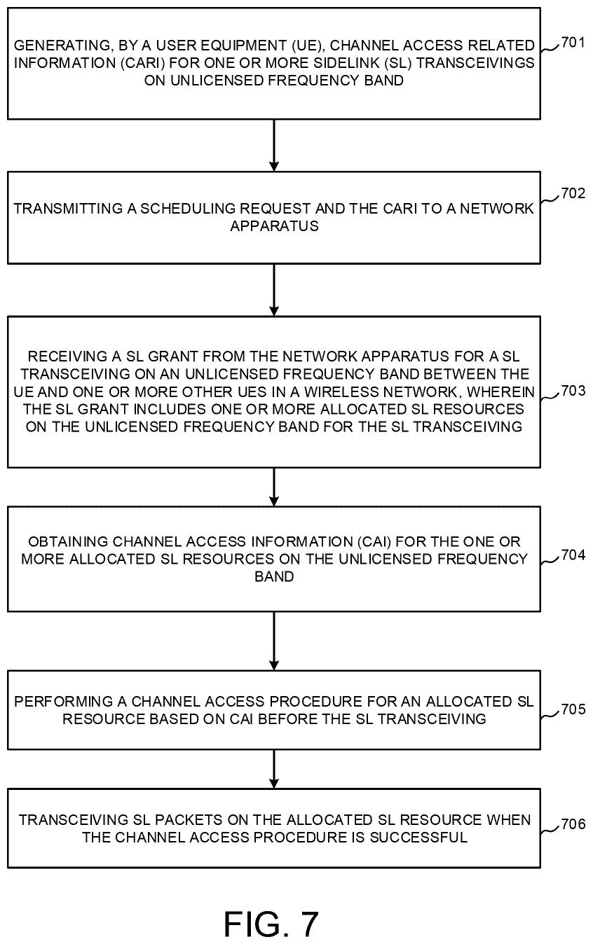

FIG. 7 illustrates an exemplary flow chart of UE for the SL resource allocation for mode-1 on unlicensed frequency bands in accordance with embodiments of the current invention. At step 701, the UE generates channel access related information (CARI) for one or more sidelink (SL) transceivings on unlicensed frequency band. At step 702, the UE transmits a scheduling request and the CARI to a network apparatus. At step 703, the UE receives a SL grant from the network apparatus for a SL transceiving on an unlicensed frequency band between the UE and one or more other UEs in a wireless network, wherein the SL grant includes one or more allocated SL resources on the unlicensed frequency band for the SL transceiving. At step 704, the UE obtains channel access information (CAI) for the one or more allocated SL resources on the unlicensed frequency band. At step 705, the UE performs a channel access procedure for an allocated SL resource based on CAI before the SL transceiving. At step 706, the UE transceives SL packets on the allocated SL resource when the channel access procedure is successful.

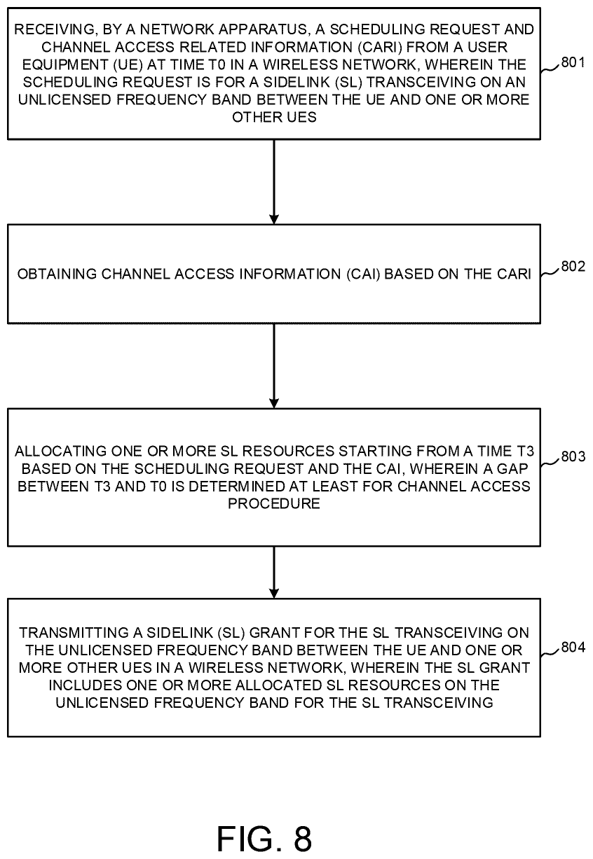

FIG. 8 illustrates an exemplary flow chart of network apparatus for the SL resource allocation for mode-1 on unlicensed frequency bands in accordance with embodiments of the current invention. At step 801, the network apparatus receives a scheduling request and channel access related information (CARI) from a user equipment (UE) at time to in a wireless network, wherein the scheduling request is for a sidelink (SL) transceiving on an unlicensed frequency band between the UE and one or more other UEs. At step 802, the network apparatus obtains channel access information (CAI) based on the CARI. At step 803, the network apparatus allocates one or more SL resources starting from a time t3 based on the scheduling request and the CAI, wherein a gap between t3 and t0 is determined at least for channel access procedure. At step 804, the network apparatus transmits a sidelink (SL) grant for the SL transceiving on the unlicensed frequency band between the UE and one or more other UEs in a wireless network, wherein the SL grant includes one or more allocated SL resources on the unlicensed frequency band for the SL transceiving.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A method, comprising:
generating, by a user equipment (UE), channel access related information (CARI) for one or more sidelink (SL) transceivings on unlicensed frequency band;
transmitting a scheduling request and the CARI to a network apparatus;
receiving a SL grant from the network apparatus for a SL transceiving on an unlicensed frequency band between the UE and one or more other UEs in a wireless network, wherein the SL grant includes one or more allocated SL resources on the unlicensed frequency band for the SL transceiving;
obtaining channel access information (CAI) for the one or more allocated SL resources on the unlicensed frequency band;
performing a channel access procedure for an allocated SL resource based on CAI before the SL transceiving; and
transceiving SL packets on the allocated SL resource when the channel access procedure is successful.

2. The method of claim 1, wherein the SL grant further includes one or more indicators comprising: a time resource indication value (TRIV), a resource reservation interval (RRI), and a resource indication, and wherein the one or more indicators indicates one or more resource types comprising an initial transmission resource, a retransmission resource, a repetition resource, a feedback resource, a shared resource, and an overbooking resource.

3. The method of claim 1, wherein the CAI includes one or more CAI elements comprising a contention window (CW) range, a CW value, a random back-off counter, a listen-before-talk (LBT) type for the channel access procedure, a LBT result, a gap margin, and a maximum channel occupancy time (COT); wherein the one or more CAI elements are determined based on one or more conditions comprising a hybrid automatic repeat request (HARQ) ACK/NACK status, and a networking loading status; wherein the CARI includes one or more CAI elements.

4. (canceled)

5. (canceled)

6. The method of claim 1, wherein the CAI includes one or more channel access information elements determined by the UE, and wherein the CAI is sent to the network apparatus on physical uplink control channel (PUCCH)/physical uplink shared channel (PUSCH)/MAC-CE.

7. The method of claim 1, wherein the CARI includes one or more CARI elements comprising a traffic type, quality of service (QoS), 5G QoS identifier (5QI), PC5 QoS identifier (PQI), and channel access priority class (CAPC); wherein the CAI is derived by the network apparatus based on at least one CARI element of the CARI from the UE, and the UE obtains the CAI from the network apparatus.

8. (canceled)

9. The method of claim 1, wherein the SL grant is a dynamic grant (DG) included in a downlink control information (DCI) or a MAC control element (CE).

10. The method of claim 1, wherein the SL grant is a configured grant (CG) included in a radio resource control (RRC) message or a MAC-CE.

11. The method of claim 1, wherein the CAI is updated for one or more latter allocated resources in the SL grant based on one or more factors comprising a HARQ feedback for an earliest successful COT, a distance Tw from an end of a reference duration corresponding to an earliest SL channel occupancy after a last update of a contention window size of a CAPC value wherein the reference duration is defined as a duration starting from the beginning of the channel occupancy until the end of a first slot where at least one unicast and/or multicast PSSCH with HARQ ACK/NACK enabled is transmitted over all the resources allocated for the PSSCH, or until the end of the first transmission burst by the UE that contains unicast PSSCH(s) transmitted over all the resources allocated for the PSSCH, whichever occurs earlier.

12. (canceled)

13. The method of claim 1, wherein the one or more allocated SL resources are overbooked for one or multiple transmissions of one or more transport blocks (TBs) from one or more UEs.

14. The method of claim 1, wherein the SL grant is received through a Uu link with the network apparatus on a licensed frequency band.

15. The method of claim 1, further comprising: sharing one or more resources within a channel occupancy time (COT) with one or more other UEs.

16. The method of claim 1, further comprising: reporting channel access result of the allocated SL resource to the network apparatus.

17. The method of claim 1, further comprising: updating the CARI based on one or more predefined conditions.

18. A method, comprising:
receiving, by a network apparatus, a scheduling request and channel access related information (CARI) from a user equipment (UE) at time to in a wireless network, wherein the scheduling request is for a sidelink (SL) transceiving on an unlicensed frequency band between the UE and one or more other UEs;
obtaining channel access information (CAI) based on the CARI;
allocating one or more SL resources starting from a time t3 based on the scheduling request and the CAI, wherein a gap between t3 and t0 is determined at least for channel access procedure; and
transmitting a sidelink (SL) grant for the SL transceiving on the unlicensed frequency band between the UE and one or more other UEs in a wireless network, wherein the SL grant includes one or more allocated SL resources on the unlicensed frequency band for the SL transceiving.

19. The method of claim 18, wherein the CAI includes one or more CAI elements comprising a contention window (CW) range, a CW value, a random back-off counter, a listen-before-talk (LBT) type for the channel access procedure, an LBT result, a gap margin, and a maximum channel occupancy time (COT); wherein the CARI includes one or more CAI elements.

20. (canceled)

21. The method of claim 18, wherein the CARI includes one or more CARI elements comprising a traffic type, quality of service (QoS), 5G QoS identifier (5QI), PC5 QoS identifier (PQI), channel access priority class (CAPC); wherein the network apparatus determines the CAI based on CAPC received from the UE.

22. (canceled)

23. The method of claim 18, wherein the gap between t0 and t3 is based on Uu link signaling receiving time, message parsing and preparation time, channel access duration, gap margin, and resource occupancy status.

24. The method of claim 18, the SL grant and the CAI are transmitted by downlink control information (DCI) or MAC-CE to one or multiple UEs.

25. The method of claim 18, further comprising updating the CAI and resource allocation based on channel access result feedback information from the UE.

26. The method of claim 18, wherein the SL grant is sent to the UE on a licensed frequency band.
